(19) United States
(12) Patent Application Publication
(10) Pub. No.: US 2025/0015686 A1
(43) Pub. Date: Jan. 9, 2025

(54) HAIRPIN GRIPPER

(71) Applicants: HYUNDAI MOTOR COMPANY, Seoul (KR); KIA CORPORATION, Seoul (KR)

(72) Inventors: Tae Kyun An, Hwaseong-si (KR); Yeong Su Yu, Ulsan (KR)

(73) Assignees: HYUNDAI MOTOR COMPANY, Seoul (KR); KIA CORPORATION, Seoul (KR)

(21) Appl. No.: 18/383,749

(22) Filed: Oct. 25, 2023

(30) Foreign Application Priority Data
Jul. 4, 2023 (KR) 10-2023-0086619

(51) Int. Cl. H02K 15/04; B25J 15/08

(52) U.S. Cl. CPC H02K 15/0421; B25J 15/08

(57) ABSTRACT

A hairpin gripper includes: a gripper main body; a first finger grip part provided on the gripper main body and configured to grip a first portion of a hairpin; and a second finger grip part provided on the gripper main body and configured to grip a second portion of the hairpin independently of the first finger grip part. As a result, the hairpin gripper obtains an advantageous effect of improving the accuracy of an operation of clamping the hairpin and improving productivity and production efficiency.

### CROSS-REFERENCE TO RELATED APPLICATION

This application claims priority to and the benefit of Korean Patent Application No. 10-2023-0086619 filed in the Korean Intellectual Property Office on Jul. 4, 2023, the entire contents of which are incorporated herein by reference.

### TECHNICAL FIELD

The present disclosure relates to a hairpin gripper, and more particularly, to a hairpin gripper capable of improving the accuracy of an operation of clamping a hairpin and improving productivity and production efficiency.

### BACKGROUND ART

A hybrid vehicle or an electric vehicle, which is called an environmentally friendly vehicle, generates driving power using an electric motor (hereinafter, referred to as a ‘drive motor’) that obtains rotational force from electrical energy.

In general, the drive motor includes a stator coupled to a housing, and a rotor rotatably disposed in the stator with a predetermined air gap from the stator.

The stator includes stator cores provided by stacking electrical steel sheets, and stator coils wound around slots of the stator cores.

Recently, a method of using a hairpin (also called a flat coil or an angular copper wire) as a stator coil has been proposed to increase the output of the motor and reduce the size of the motor.

Unlike an annular coil in the related art having a circular cross-section, the hairpin has an angular cross-section (e.g., a quadrangular cross-section), which can advantageously minimize a dead space (dead zone) in a slot of the stator and maximize a space factor of the stator coil.

The hairpin supplied to a cartridge (hairpin supply cartridge) may be transferred to a temporary alignment jig by a robot (or loader), subjected to a temporary alignment process, and then inserted into a stator core.

However, in the related art, there is a problem in that it is difficult to accurately grip (clamp) the hairpin because of forming deviation (forming dispersion) of the hairpin even though the robot capable of performing precision control is used. For this reason, there is a problem in that it is difficult to accurately transfer the hairpin to the temporary alignment jig.

In addition, there is a problem in that, when leg portions (leg portions to be inserted into slots of a stator core) of the hairpin are deformed by being spread or bent with respect to a crown portion of the hairpin (or a forming deviation occurs), it is difficult to accurately insert the leg portions of the hairpin into the target positions (temporary alignment positions) on the temporary alignment jig even though the hairpin is accurately gripped. For this reason, there is a problem in that productivity and production efficiency deteriorate.

Therefore, recently, various studies have been conducted to improve the accuracy of the operation of clamping the hairpin and improve productivity and production efficiency, but the study results are still insufficient. Accordingly, there is a need to develop a technology to improve the accuracy of the operation of clamping the hairpin and improve productivity and production efficiency.

### SUMMARY

The present disclosure has been made in an effort to provide a hairpin gripper capable of improving the accuracy of an operation of clamping a hairpin and improving productivity and production efficiency.

In particular, the present disclosure has been made in an effort to grip the hairpin in an accurate posture and improve the performance and stability of the operation of gripping the hairpin.

The present disclosure has also been made in an effort to accurately insert the hairpin into a target position (temporary alignment position) on a temporary alignment jig.

Among other things, the present disclosure has been made in an effort to accurately position the hairpin at the target position while mitigating deformation of the hairpin (minimizing deformation and distortion) even when the hairpin is deformed (or a forming deviation occurs).

The present disclosure has also been made in an effort to improve the efficiency of a process of temporarily aligning the hairpin, reduce the amount of time required for the process of temporarily aligning the hairpin, and improve production quality.

The objects to be achieved by the embodiments of the present disclosure are not limited to the above-mentioned objects, but also include objects or effects that may be understood from the solutions or embodiments described below.

An embodiment of the present disclosure provides a hairpin gripper including: a gripper main body; a first finger grip part provided on the gripper main body and configured to grip a first portion of a hairpin; and a second finger grip part provided on the gripper main body and configured to grip a second portion of the hairpin independently of the first finger grip part.

This is to improve the accuracy of an operation of clamping the hairpin and improve the productivity and production efficiency.

In other words, in the related art, there is a problem in that it is difficult to accurately grip the hairpin because of forming deviation (forming dispersion) of the hairpin even though the robot capable of performing precision control is used. For this reason, there is a problem in that it is difficult to accurately transfer the hairpin to the temporary alignment jig.

In addition, there is a problem in that, when leg portions (leg portions to be inserted into slots of a stator core) of the hairpin are deformed by being spread or bent with respect to a crown portion of the hairpin (or a forming deviation occurs), it is difficult to accurately insert the leg portions of the hairpin into the target positions (temporary alignment positions) on the temporary alignment jig even though the hairpin is accurately gripped. For this reason, there is a problem in that productivity and production efficiency deteriorate.

In contrast, in an embodiment of the present disclosure, the first finger grip part and the second finger grip part may independently grip the hairpin. Therefore, it is possible to obtain an advantageous effect of gripping (clamping) the hairpin in an accurate posture and improving the accuracy of the operation of clamping the hairpin.

Among other things, in an embodiment of the present disclosure, the first finger grip part and the second finger grip part may independently grip the different portions (the first portion and the second portion) of the hairpin without simultaneously gripping the hairpin. Therefore, even when the hairpin is deformed (a forming deviation occurs), the first finger grip part and the second finger grip part may each always grip the hairpin at a predetermined position. Therefore, it is possible to obtain an advantageous effect of improving the gripping efficiency and accuracy of the first finger grip part and the second finger grip part.

According to the embodiment of the present disclosure, the hairpin may include: a crown portion; a first leg portion connected to one end of the crown portion; and a second leg portion connected to a second end of the crown portion. Additionally, the first portion may be defined as a boundary between the crown portion and the first leg portion, and the second portion may be defined as a boundary between the crown portion and the second leg portion.

Process methods, such as Numerical Control (NC) bending and pressing, are used to manufacture the hairpin from a straight coil. In this case, the forming quality of the boundary (soldered portion) between the crown portion and the leg portion (the first leg portion and the second leg portion) is high (forming deviation is small). However, the leg portion (the first leg portion or the second leg portion), which serves as a criterion for the insertion of the temporary alignment jig, increases in dimension dispersion toward the end thereof because of springback and thus is easily deformed.

In other words, in an embodiment of the present disclosure, the first finger grip part and the second finger grip part may grip the boundaries (soldered portions) between the crown portion and the leg portions (the first leg portion and the second leg portion). These boundaries (soldered portions) have the smallest forming deviation in the hairpin. Therefore, it is possible to obtain an advantageous effect of further improving the accuracy of the operation of clamping the hairpin.

The first finger grip part may have various structures capable of gripping the first portion of the hairpin.

According to the embodiment of the present disclosure, the first finger grip part may include a first finger and a second finger. The second finger of the first finger grip part may be configured to be movable toward or away from the first finger such that the first finger and the second finger collectively grip the first portion of the hairpin.

The second finger grip part may have various structures capable of gripping the second portion of the hairpin.

According to the embodiment of the present disclosure, the second finger grip part may also include a first finger and a second finger. The second finger of the second finger grip part may be configured to be movable toward or away from the first finger such that the first finger and the second finger collectively grip the second portion of the hairpin.

According to the embodiment of the present disclosure, the hairpin gripper may further include, as a part of the first finger grip part, a first guide portion provided on the first finger and configured to guide one surface of the hairpin a second guide portion provided on the second finger and configured to face the first guide portion and guide a second surface of the hairpin. The first portion of the hairpin may be guided along the first guide portion and the second guide portion and aligned between the first finger and the second finger.

With the above-mentioned structure, when the first finger and the second finger of the first finger grip part move toward each other, the first portion of the hairpin may be guided along a first inclined surface and a second inclined surface of the first guide portion and the second guide portion and aligned in the preset posture and at the preset position (the posture and position at which the gripped state may be stably maintained) between the first finger and the second finger. All the four sides of the first portion of the hairpin may be restrained by (come into surface contact with) the first finger, the second finger, the first guide portion, and the second guide portion.

According to an embodiment of the present disclosure, the hairpin gripper may also include, as a part of the second finger grip part, a first guide portion provided on the first finger and configured to guide one surface of the hairpin and a second guide portion provided on the second finger and configured to face the first guide portion and guide a second surface of the hairpin. The second portion of the hairpin is guided along the first guide portion and the second guide portion and aligned between the first finger and the second finger.

With the above-mentioned structure, when the first finger part and the second finger part of the second finger grip part move toward each other, the second portion of the hairpin may be guided along a first inclined surface and a second inclined surface of the first guide portion and the second guide portion and aligned in the preset posture and at the preset position (the posture and position at which the gripped state may be stably maintained) between the first finger and the second finger. All the sides of the second portion of the hairpin may be restrained by (come into surface contact with) the first finger, the second finger, the first guide portion, and the second guide portion.

According to an embodiment of the present disclosure, the second finger grip part may be provided to be selectively movable rectilinearly toward or away from the first finger grip part.

This is to handle (grip) hairpins having various sizes without changing the hairpin grippers.

In other words, the size of the hairpin (e.g., the widths of the first and second leg portions) may be variously changed in accordance with required conditions and design specifications. In an embodiment of the present disclosure, the second finger grip part may rectilinearly move relative to the first finger grip part (the second finger grip part rectilinearly moves toward or away from the first finger grip part) based on the size of the hairpin. Therefore, it is possible to handle (grip) hairpins having various sizes without changing the hairpin grippers.

According to an embodiment of the present disclosure, the hairpin gripper may include a drive part configured to provide driving power that allows the second finger grip part to rectilinearly move toward or away from the first finger grip part.

According to an embodiment of the present disclosure, the hairpin gripper may include a lifting part provided on the gripper main body and configured to selectively lift the crown portion when the first finger grip part and the second finger grip part grip the hairpin.

The lifting part may have various structures capable of lifting the crown portion of the hairpin.

According to an embodiment of the present disclosure, the lifting part may include a lifting member provided on the gripper main body and configured to be selectively movable upward or downward. The lifting part may also include a hook member provided on the lifting member and configured to support the crown portion.

With the above-mentioned structure, when the crown portion is moved upward by the hook member by an upward movement of the lifting member, the first leg portion and the second leg portion move upward when the first leg portion and the second leg portion are gripped by the first finger grip part and the second finger grip part. As a result, the deformation of the first leg portion and/or the second leg portion may be mitigated (the first leg portion and/or the second leg portion may be aligned in the preset posture).

According to the embodiment of the present disclosure, the hairpin gripper may include a lifting drive part configured to provide driving power that allows the lifting member to move upward relative to the gripper main body.

According to the embodiment of the present disclosure, the reference height of the hook member may vary in conjunction (synchronization) with the rectilinear movement of the second finger grip part relative to the first finger grip part depending on the size of the hairpin.

According to the embodiment of the present disclosure, the hairpin gripper may include a cam follower provided on the gripper main body and configured to be selectively movable upward or downward and support the lifting member. The hairpin gripper may also include a first link member having one end, i.e., a first end, rotatably connected to the first finger grip part, and the other end, i.e., a second end, rotatably connected to the cam follower. The hairpin gripper may also include a second link member having one end, i.e., a first end, rotatably connected to the second finger grip part, and the other end, i.e., a second end, rotatably connected to the other end of the first link member. The lifting member may move upward or downward based on the upward or downward movement of the cam follower.

As described above, according to the embodiment of the present disclosure, the reference height of the hook member may vary depending on the rectilinear movement of the second finger grip part relative to the first finger grip part (based on the change in size of the hairpin). Therefore, it is possible to obtain an advantageous effect of preventing interference between the hook member and the hairpin caused by the change in size of the hairpin.

### BRIEF DESCRIPTION OF THE DRAWINGS

FIG. 1 is a perspective view of a hairpin gripper according to an embodiment of the present disclosure.

FIG. 2 is a front view of the hairpin gripper according to the embodiment of the present disclosure.

FIG. 3 is a view of first and second grip parts of the hairpin gripper according to the embodiment of the present disclosure.

FIG. 4 is a view of operational structures of the first and second grip parts of the hairpin gripper according to the embodiment of the present disclosure.

FIG. 5 is a view of a lifting part of the hairpin gripper according to the embodiment of the present disclosure.

FIG. 6 is a view of a state in which a hairpin is gripped by the hairpin gripper according to the embodiment of the present disclosure.

FIG. 7 is a view of a state in which a hairpin is lifted by the hairpin gripper according to the embodiment of the present disclosure.

### DETAILED DESCRIPTION

Hereinafter, embodiments of the present disclosure are described in detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by those having ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, it should be understood that one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

When a component, device, element, or the like of the present disclosure is described as having a purpose or performing an operation, function, or the like, the component, device, or element should be considered herein as being “configured to” meet that purpose or perform that operation or function.

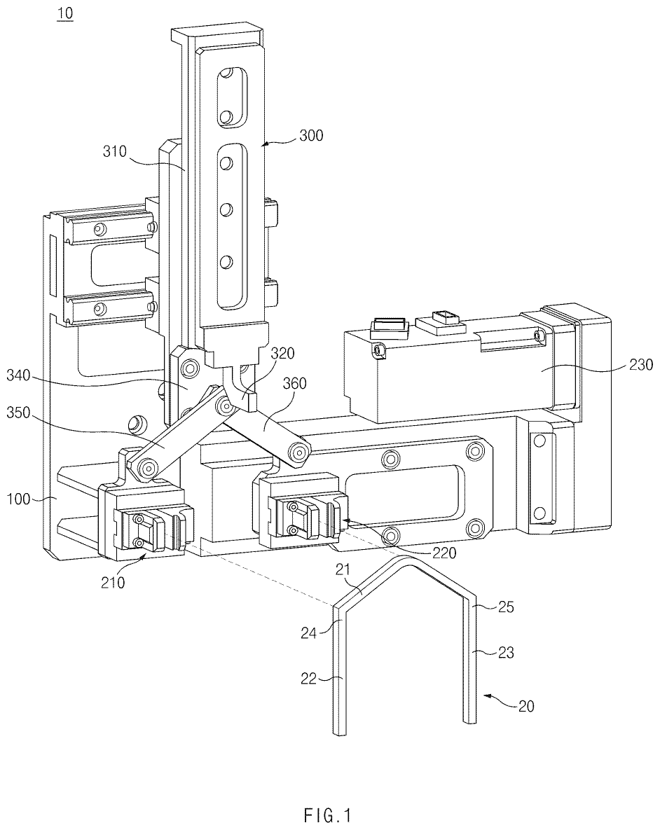

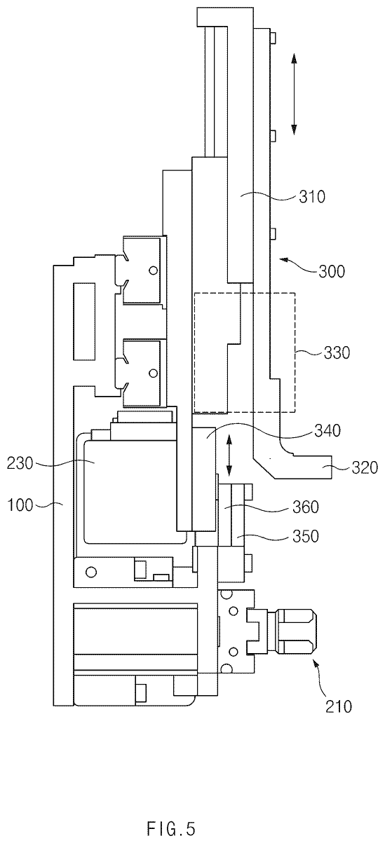

With reference to FIGS. 1-7, a hairpin gripper 10 according to an embodiment of the present disclosure includes a gripper main body 100. The hairpin gripper 10 also includes a first finger grip part 210 provided on the gripper main body 100 and configured to finger-grip (e.g., grip) a first portion 24 of a hairpin 20. The hairpin gripper 10 also includes a second finger grip part 220 provided on the gripper main body 100 and configured to finger-grip a second portion 25 of the hairpin 20 independently of the first finger grip part 210.

The hairpin gripper 10 according to the embodiment of the present disclosure may be used to grip (clamp) the hairpin 20 (also called a flat coil or an angular copper wire) used as a stator coil for a motor. The present disclosure is not restricted or limited by the type and structure of the motor to which the hairpin 20 is applied.

For example, the motor, to which the hairpin 20 is applied, may be used as a drive motor for an environmentally-friendly vehicle, such as a hybrid vehicle and/or an electric vehicle, which obtains driving power from electrical energy.

Hereinafter, an example is described in which the hairpin gripper 10 according to the embodiment of the present disclosure is used to grip the hairpin 20 supplied to a hairpin supply cartridge and transfer the hairpin to a target position on a temporary alignment jig.

For reference, the hairpin 20 may have an approximately “U” shape and include a crown portion 21, a first leg portion 22 connected to one end of the crown portion 21, and a second leg portion 23 connected to the other end of the crown portion 21.

The gripper main body 100 may have various structures capable of supporting the first finger grip part 210 and the second finger grip part 220. The present disclosure is not restricted or limited by the structure and shape of the gripper main body 100.

For reference, in an embodiment of the present disclosure, the configuration in which the first finger grip part 210 and the second finger grip part 220 are supported by the gripper main body 100 is defined as including two configurations. The first configuration supports a setup in which the first finger grip part 210 or the second finger grip part 220 is fixed to the gripper main body 100. The second configuration supports a setup in which the first finger grip part 210 or the second finger grip part 220 is movably supported on the gripper main body 100.

For example, the gripper main body 100 may have an approximately flat plate shape. The first finger grip part 210 and the second finger grip part 220 may be supported at a lower end of a front surface of the gripper main body 100 (based on FIG. 1).

With reference to FIGS. 1-4, the first finger grip part 210 is provided on the gripper main body 100 and configured to finger-grip the first portion 24 of the hairpin 20.

For reference, in an embodiment of the present disclosure, the configuration in which the first finger grip part 210 finger-grips the first portion 24 of the hairpin 20 may be defined as a configuration in which the first finger grip part 210 grips the first portion 24 of the hairpin 20 as if two fingers grasp the first portion 24 of the hairpin 20.

The first portion 24 of the hairpin 20, which is gripped by the first finger grip part 210, may be defined at various positions in accordance with required conditions and design specifications. The present disclosure is not restricted or limited by the position of the first portion 24.

According to an embodiment of the present disclosure, the first portion 24 of the hairpin 20 may be defined as a boundary (soldered portion) between the crown portion 21 and the first leg portion 22.

Process methods, such as Numerical Control (NC) bending and pressing, are used to manufacture the hairpin 20 from a straight coil. In this case, the forming quality of the boundary (soldered portion) between the crown portion 21 and the leg portion (the first leg portion 22 and the second leg portion 23) is high (forming deviation is small). However, the leg portion (the first leg portion 22 or the second leg portion 23), which serves as a criterion for the insertion of the temporary alignment jig, increases in dimension dispersion toward the end thereof because of springback and thus is easily deformed.

In other words, the first finger grip part 210 may be configured to grip the boundary (soldered portion) between the crown portion 21 and the first leg portion 22, and the boundary has a small or minor forming deviation in the hairpin 20.

The first finger grip part 210 may have various structures capable of finger-gripping the first portion 24 of the hairpin 20. The present disclosure is not restricted or limited by the structure of the first finger grip part 210.

According to an embodiment of the present disclosure, the first finger grip part 210 may include a first-first finger part (e.g., first finger) 212, and a first-second finger part (e.g., second finger) 214. The first-second finger part 214 is configured to be movable toward or away from the first-first finger part 212 such that the first-first finger part 212 and the first-second finger part 214 collectively grip the first portion 24 of the hairpin 20. The first portion 24 of the hairpin 20 may be gripped (clamped) between the first-first finger part 212 and the first-second finger part 214.

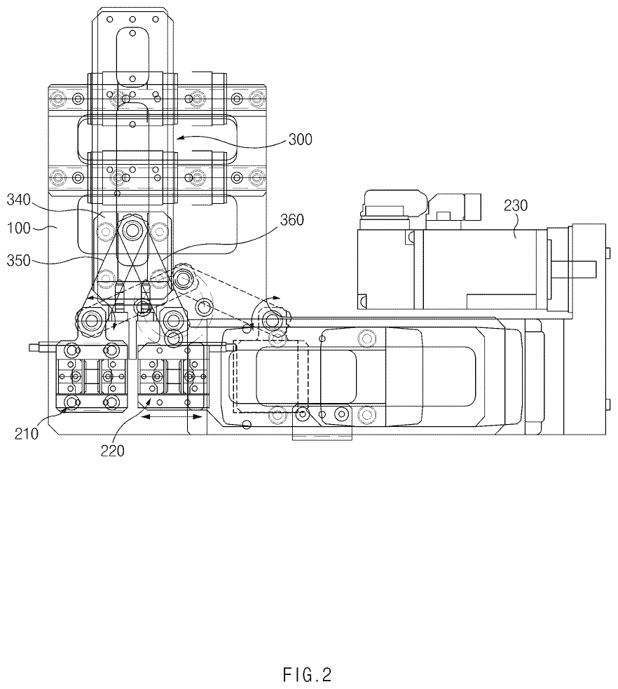

Hereinafter, an example is described in which both the first-first finger part 212 and the first-second finger part 214 are configured to be rectilinearly movable in the direction in which the first-first finger part 212 and the first-second finger part 214 move toward or away from each other (both the first-first finger part and the first-second finger part are configured to be movable in a leftward/rightward direction based on FIG. 2).

For example, the first-first finger part 212 and the first-second finger part 214 may be configured to be rectilinearly movable on the gripper main body 100 by a typical (linear motion) LM guide. The first-first finger part 212 and the first-second finger part 214 may be configured to be rectilinearly movable in the direction in which the first-first finger part 212 and the first-second finger part 214 are moved toward or away from each other by driving power of a driving source such as an air cylinder.

According to another embodiment of the present disclosure, any one of the first-first finger part 212 and the first-second finger part 214 may be fixed, and only the other of the first-first finger part 212 and the first-second finger part 214 may be configured to be rectilinearly movable.

With reference to FIGS. 1-4, the second finger grip part 220 is provided on the gripper main body 100 and configured to finger-grip (e.g., grip) the second portion 25 of the hairpin 20 independently of the first finger grip part 210.

For reference, in an embodiment of the present disclosure, the configuration in which the second finger grip part 220 finger-grips the second portion 25 of the hairpin 20 may be defined as a configuration in which the second finger grip part 220 grips the second portion 25 of the hairpin 20 as if two fingers grasp the second portion 25 of the hairpin 20.

The second portion 25 of the hairpin 20, which is gripped by the second finger grip part 220, may be defined at various positions in accordance with required conditions and design specifications. The present disclosure is not restricted or limited by the position of the second portion 25.

According to an embodiment of the present disclosure, the second portion 25 of the hairpin 20 may be defined as a boundary (soldered portion) between the crown portion 21 and the second leg portion 23.

Process methods, such as NC bending and pressing, are used to manufacture the hairpin 20 from a straight coil. In this case, the forming quality of the boundary (soldered portion) between the crown portion 21 and the leg portion (the first leg portion 22 and the second leg portion 23) is high (forming deviation is small). However, the leg portion (the first leg portion 22 or the second leg portion 23), which serves as a criterion for the insertion of the temporary alignment jig, increases in dimension dispersion toward the end thereof because of springback and thus is easily deformed.

In other words, the second finger grip part 220 may be configured to grip the boundary (soldered portion) between the crown portion 21 and the second leg portion 23, and the boundary has a small or minor forming deviation in the hairpin 20.

The second finger grip part 220 may have various structures capable of finger-gripping the second portion 25 of the hairpin 20. The present disclosure is not restricted or limited by the structure of the second finger grip part 220.

According to an embodiment of the present disclosure, the second finger grip part 220 may include a second-first finger part (e.g., first finger) 222, and a second-second finger part (e.g., second finger) 224. The second-second finger part 224 is configured to be movable toward or away from the second-first finger part 222 such that the second-first finger part 222 and the second-second finger part 224 collectively grip the second portion 25 of the hairpin 20. The second portion 25 of the hairpin 20 may be gripped (clamped) between the second-first finger part 222 and the second-second finger part 224.

Hereinafter, an example is described in which both the second-first finger part 222 and the second-second finger part 224 are configured to be rectilinearly movable in the direction in which the second-first finger part 222 and the second-second finger part 224 move toward or away from each other (both the second-first finger part and the second-second finger part are configured to movable in the leftward/rightward direction based on FIG. 2).

For example, the second-first finger part 222 and the second-second finger part 224 may be configured to be rectilinearly movable on the gripper main body 100 by a typical (linear motion) LM guide. The second-first finger part 222 and the second-second finger part 224 may be configured to be rectilinearly movable in the direction in which the second-first finger part 222 and the second-second finger part 224 are moved toward or away from each other by the driving power of the driving source such as an air cylinder.

According to another embodiment of the present disclosure, any one of the second-first finger part 222 and the second-second finger part 224 may be fixed, and only the other of the second-first finger part 222 and the second-second finger part 224 may be configured to be rectilinearly movable.

As described above, in an embodiment of the present disclosure, the first finger grip part 210 and the second finger grip part 220 may independently grip the hairpin 20. Therefore, it is possible to obtain an advantageous effect of gripping the hairpin 20 in an accurate posture and improving the accuracy of the operation of clamping the hairpin 20.

Among other things, in an embodiment of the present disclosure, the first finger grip part 210 and the second finger grip part 220 may independently finger-grip the different portions (the first portion and the second portion) of the hairpin 20 without simultaneously gripping the hairpin 20. Therefore, even when the hairpin 20 is deformed (a forming deviation occurs), the first finger grip part 210 and the second finger grip part 220 may each always grip the hairpin 20 at a predetermined position. Therefore, it is possible to obtain an advantageous effect of improving the gripping efficiency and accuracy of the first finger grip part 210 and the second finger grip part 220.

Moreover, in an embodiment of the present disclosure, the first finger grip part 210 and the second finger grip part 220 may grip the boundaries (soldered portions) between the crown portion 21 and the leg portions (the first leg portion 22 and the second leg portion 23). The boundaries (soldered portions) have the smallest forming deviation in the hairpin 20. Therefore, it is possible to obtain an advantageous effect of further improving the accuracy of the operation of clamping the hairpin 20.

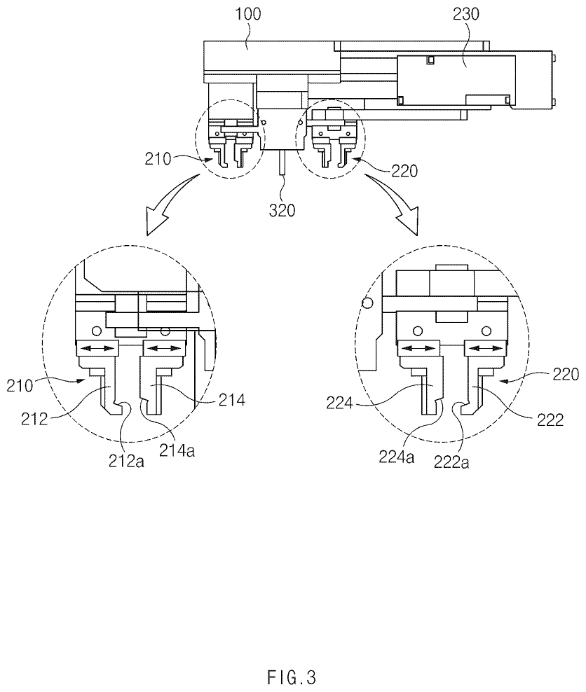

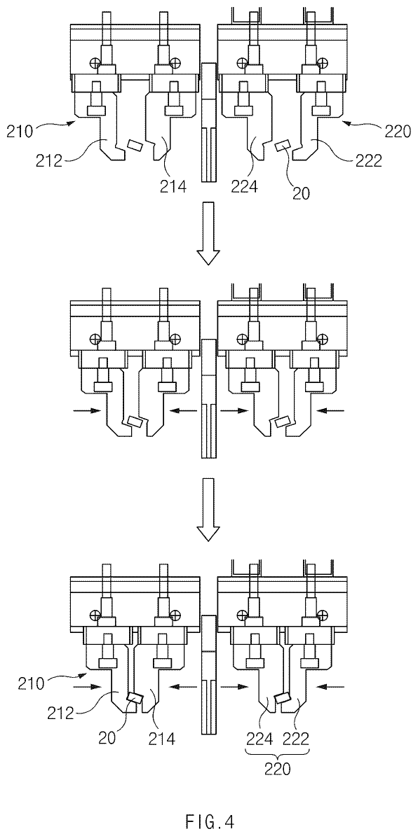

With reference to FIGS. 3 and 4, according to the embodiment of the present disclosure, the hairpin gripper 10 may include a first-first guide portion (e.g., first guide portion) 212a provided on the first-first finger part 212 and configured to guide one surface of the hairpin 20. The hairpin gripper 10 may also include a first-second guide portion (e.g., second guide portion) 214a provided on the first-second finger part 214 and configured to face the first-first guide portion 212a and guide the other (e.g., second) surface of the hairpin 20. The first portion 24 of the hairpin 20 may be guided along the first-first guide portion 212a and the first-second guide portion 214a and aligned between the first-first finger part 212 and the first-second finger part 214.

The first-first guide portion 212a and the first-second guide portion 214a may have various structures capable of aligning the first portion 24 of the hairpin 20 in a preset posture and at a preset position between the first-first finger part 212 and the first-second finger part 214. The present disclosure is not restricted or limited by the structures and shapes of the first-first guide portion 212a and the first-second guide portion 214a.

For example, the first-first guide portion 212a may have a first-first inclined surface (e.g., flat surface) inclined with respect to the front surface of the gripper main body 100. The first-second guide portion 214a may have a first-second inclined surface (e.g., flat surface) that faces the first-first guide portion 212a.

With the above-mentioned structure, when the first-first finger part 212 and the first-second finger part 214 move toward each other, the first portion 24 of the hairpin 20 may be guided along the first-first inclined surface and the first-second inclined surface of the first-first guide portion 212a and the first-second guide portion 214a. Furthermore, the first portion 24 of the hairpin 20 may be aligned in the preset posture and at the preset position (the posture and position at which the gripped state may be stably maintained) between the first-first finger part 212 and the first-second finger part 214. All four sides of the first portion 24 of the hairpin 20 may be restrained by (come into surface contact with) the first-first finger part 212, the first-second finger part 214, the first-first guide portion 212a, and the first-second guide portion 214a.

In addition, with reference to FIGS. 3 and 4, according to the embodiment of the present disclosure, the hairpin gripper 10 may include a second-first guide portion (e.g., first guide portion) 222a provided on the second-first finger part 222 and configured to guide one surface of the hairpin 20. The hairpin gripper 10 may also include a second-second guide portion (e.g., second guide portion) 224a provided on the second-second finger part 224 and configured to face the second-first guide portion 222a and guide the other (e.g., second) surface of the hairpin 20. The second portion 25 of the hairpin 20 may be guided along the second-first guide portion 222a and the second-second guide portion 224a and aligned between the second-first finger part 222 and the second-second finger part 224.

The second-first guide portion 222a and the second-second guide portion 224a may have various structures capable of aligning the second portion 25 of the hairpin 20 in a preset posture and at a position between the second-first finger part 222 and the second-second finger part 224. The present disclosure is not restricted or limited by the structures and shapes of the second-first guide portion 222a and the second-second guide portion 224a.

For example, the second-first guide portion 222a may have a second-first inclined surface (e.g., flat surface) inclined with respect to the front surface of the gripper main body 100. The second-second guide portion 224a may have a second-second inclined surface (e.g., flat surface) that faces the second-first guide portion 222a.

With the above-mentioned structure, when the second-first finger part 222 and the second-second finger part 224 move toward each other, the second portion 25 of the hairpin 20 may be guided along the second-first inclined surface and the second-second inclined surface of the second-first guide portion 222a and the second-second guide portion 224a. Furthermore, the second portion 25 of the hairpin 20 may be aligned in the preset posture and at the preset position (the posture and position at which the gripped state may be stably maintained) between the second-first finger part 222 and the second-second finger part 224. All the sides of the second portion 25 of the hairpin 20 may be restrained by (come into surface contact with) the second-first finger part 222, the second-second finger part 224, the second-first guide portion 222a, and the second-second guide portion 224a.

According to an embodiment of the present disclosure, the second finger grip part 220 may be provided to be selectively movable rectilinearly toward or away from the first finger grip part 210.

This configuration is to handle (grip) the hairpins 20 having various sizes without changing the hairpin grippers 10.

In other words, the size of the hairpin 20 (e.g., the widths of the first and second leg portions) may be variously changed in accordance with required conditions and design specifications. In the embodiment of the present disclosure, the second finger grip part 220 may rectilinearly move relative to the first finger grip part 210 (the second finger grip part 220 rectilinearly moves toward or away from the first finger grip part) based on the size of the hairpin 20. Therefore, it is possible to handle (grip) the hairpins 20 having various sizes without changing the hairpin grippers 10.

For example, the second finger grip part 220 may be configured to be rectilinearly movable on the gripper main body 100 by a typical linear motion (LM) guide. The present disclosure is not restricted or limited by the type and properties of the LM guide.

According to an embodiment of the present disclosure, the hairpin gripper 10 may include a drive part 230 configured to provide driving power that allows the second finger grip part 220 to rectilinearly move toward or away from the first finger grip part 210.

Various drive means capable of providing the driving power, which allows the second finger grip part 220 to rectilinearly move relative to the first finger grip part 210, may be used as the drive part 230. The present disclosure is not restricted or limited by the type and structure of the drive part 230.

For example, a servo cylinder, which may precisely control the movement of the second finger grip part 220 relative to the first finger grip part 210 depending on a size of the hairpin 20 (widths of the first and second leg portions), may be used as the drive part 230.

According to another embodiment of the present disclosure, the second finger grip part 220 may be configured to be moved by a lead screw that is rotated by a motor. Alternatively, the second finger grip part 220 may be configured to be moved by a linear motor, a solenoid, or the like.

In an embodiment of the present disclosure illustrated and described above, the example has been described in which the first finger grip part 210 is fixed to the gripper main body 100, and the second finger grip part 220 rectilinearly moves relative to the first finger grip part 210. However, according to another embodiment of the present disclosure, the second finger grip part 220 may be fixed to the gripper main body 100, and the first finger grip part 210 may rectilinearly move relative to the second finger grip part 220.

With reference to FIGS. 1, 5, and 7, according to an embodiment of the present disclosure, the hairpin gripper 10 may include a lifting part 300 provided on the gripper main body 100. The lifting part 300 may be configured to selectively lift the crown portion 21 when the first finger grip part 210 and the second finger grip part 220 grip the hairpin 20.

The lifting part 300 is provided to mitigate the deformation of the leg portions (the first leg portion 22 and the second leg portion 23) (minimize the deformation and distortion) and configured to lift (raise) the hairpin 20 when the first finger grip part 210 and the second finger grip part 220 grip the hairpin 20.

This is based on the fact that the shapes of the first and second leg portions 22 and 23 of the hairpin 20 may be easily controlled (the deformation of the first and second leg portions 22 and 23 may be mitigated) with a comparatively low force. This is unlike the boundaries (the first and second portions) between the crown portion 21 and the leg portions (first 22 and second 23 leg portions) that are plastically deformed at the time of manufacturing the hairpin 20.

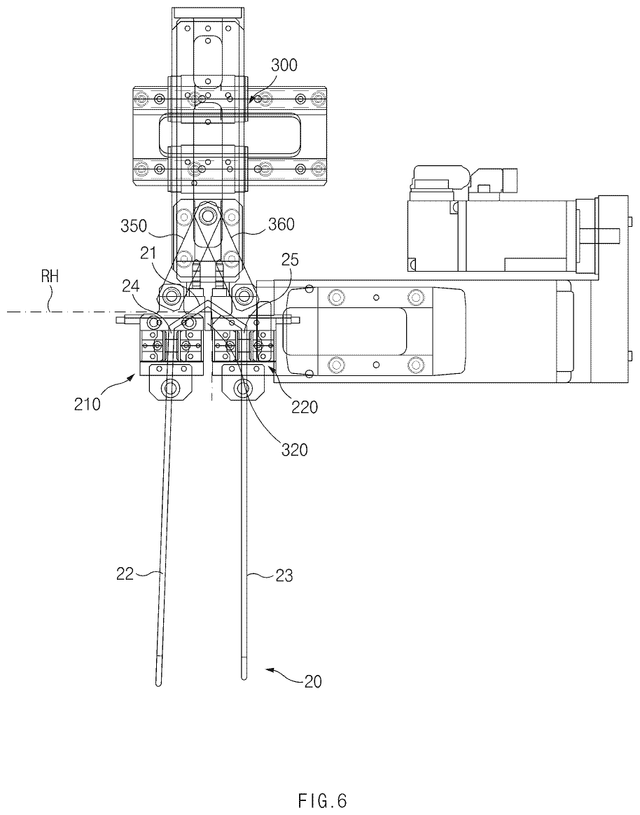

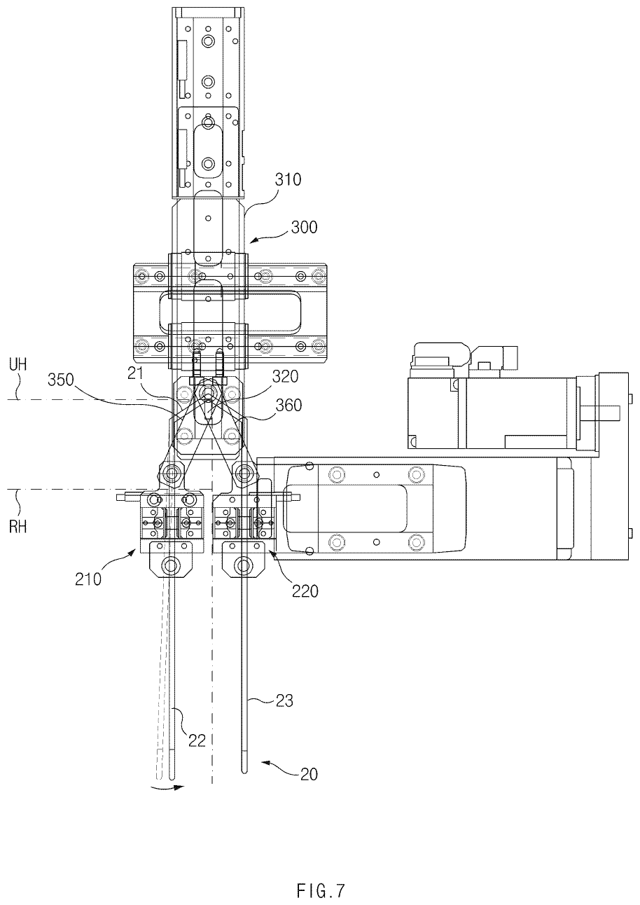

For example, as illustrated in FIGS. 6 and 7, in case that the first leg portion 22 and/or the second leg portion 23 is/are deformed by being spread outward, the hairpin 20 may be lifted upward when the first finger grip part 210 and the second finger grip part 220 grip the hairpin 20. As a result, the deformation of the first leg portion 22 and/or the second leg portion 23 may be mitigated (the first leg portion 22 and/or the second leg portion 23 may be aligned in the preset posture) while the first leg portion 22 and/or the second leg portion 23 passes/pass through the first finger grip part 210 and the second finger grip part 220.

The lifting part 300 may have various structures capable of lifting the crown portion 21 of the hairpin 20 when the first and second leg portions 22 and 23 of the hairpin 20 are respectively clamped by the first and second finger grip parts 210 and 220. The present disclosure is not restricted or limited by the structure of the lifting part 300.

According to an embodiment of the present disclosure, the lifting part 300 may include a lifting member (e.g., an elevating part) 310 provided on the gripper main body 100 and configured to be selectively movable upward or downward. The lifting part 300 may also include a hook member (e.g., hook) 320 provided on the lifting member 310 and configured to support the crown portion 21.

The lifting member 310 may have various structures capable of being disposed on the gripper main body 100, provided above the hairpin 20, and rectilinearly moving in the upward/downward direction by a typical linear motion (LM) guide. The present disclosure is not restricted or limited by the structure and shape of the lifting member 310.

The hook member 320 may have various structures capable of supporting the crown portion 21. The present disclosure is not restricted or limited by the structure and shape of the hook member 320. For example, the hook member 320 may have an approximately “J” shape and support the crown portion 21 by catching a lower portion of the crown portion 21.

For reference, a lifting distance of the hairpin 20 made by the lifting part 300 may vary depending on a deformation degree and a deformed portion of the first and second leg portions 22 and 23. The present disclosure is not restricted or limited by the lifting distance of the hairpin 20. For example, the lifting part 300 may be configured to lift the hairpin 20 (the crown portion) up to a lifting height UH spaced apart from a reference height RH near 50 mm.

With the above-mentioned structure, when the crown portion 21 is moved upward by the hook member 320 by an upward movement of the lifting member 310, the first leg portion 22 and the second leg portion 23 move upward when the first leg portion 22 and the second leg portion 23 are gripped by the first finger grip part 210 and the second finger grip part 220. As a result, the deformation of the first leg portion 22 and/or the second leg portion 23 may be mitigated (the first leg portion 22 and/or the second leg portion 23 may be aligned in the preset posture).

According to an embodiment of the present disclosure, the hairpin gripper 10 may include a lifting drive part 330 configured to provide driving power that allows the lifting member 310 to move upward relative to the gripper main body 100.

Various drive means capable of providing the driving power, which allows the lifting member 310 to move upward relative to the gripper main body 100, may be used as the lifting drive part 330. The present disclosure is not restricted or limited by the type and structure of the drive part 230.

For example, a typical air cylinder may be used as the lifting drive part 330. According to another embodiment of the present disclosure, the lifting member 310 may be moved upward or downward by a lead screw that is rotated by the motor. Alternatively, the lifting member 310 may be configured to be moved upward or downward by a linear motor, a solenoid, or the like.

The hairpin 20 may be variously changed in size in accordance with required conditions and design specifications. According to an embodiment of the present disclosure, the reference height RH of the hook member 320 may vary in conjunction (synchronization) with the rectilinear movement of the second finger grip part 220 relative to the first finger grip part 210 depending on the size of the hairpin 20.

For example, when the size of the hairpin 20 increases (the width of the leg portion increases), the reference height RH of the hook member 320 needs to be decreased. The reference height RH of the hook member 320 may vary while being synchronized with the rectilinear movement of the second finger grip part 220 relative to the first finger grip part 210.

The reference height RH of the hook member 320 may be synchronized with the rectilinear movement of the second finger grip part 220 relative to the first finger grip part 210 in various ways in accordance with required conditions and design specifications. The present disclosure is not restricted or limited by the synchronization structure between the second finger grip part 220 and the hook member 320.

With reference to FIGS. 1 and 2, according to the embodiment of the present disclosure, the hairpin gripper 10 may include a cam follower 340 provided on the gripper main body 100 and configured to be selectively movable upward or downward and support the lifting member 310. The hairpin gripper 10 may also include a first link member (e.g., first link) 350 having one end rotatably connected to the first finger grip part 210, and the other end (e.g., second end) rotatably connected to the cam follower 340. The hairpin gripper 10 may also include a second link member (e.g., second link) 360 having one end rotatably connected to the second finger grip part 220, and the other end (e.g., second end) rotatably connected to the other end of the first link member 350. The lifting member 310 may move upward or downward based on the upward or downward movement of the cam follower 340.

The cam follower 340 may have various structures capable of moving upward or downward relative to the gripper main body 100. The present disclosure is not restricted or limited by the structure and shape of the cam follower 340.

The first link member 350 and the second link member 360 may be rotatably connected to the cam follower 340 while collectively defining an approximately “V” shape. The upward or downward position of the cam follower 340 may be adjusted (the reference height of the hook member may vary) as one end of the second link member 360 moves toward or away from one end of the first link member 350 (the second finger grip part rectilinearly moves relative to the first finger grip part).

For example, when the second finger grip part 220 rectilinearly moves away from the first finger grip part 210 based on the increase in size of the hairpin 20 (the increase in width of the leg portion), the first and second link members 350 and 360 connected to the first and second finger grip parts 210 and 220 operate in conjunction with each other, such that the cam follower 340 may move downward, and the reference height RH of the hook member 320 may be lowered.

As described above, according to an embodiment of the present disclosure, the reference height RH of the hook member 320 may vary depending on the rectilinear movement of the second finger grip part 220 relative to the first finger grip part 210 (based on the change in size of the hairpin). Therefore, it is possible to obtain an advantageous effect of preventing interference between the hook member 320 and the hairpin 20 caused by the change in size of the hairpin 20.

According to an embodiment of the present disclosure described above, it is possible to obtain an advantageous effect of improving the accuracy of the operation of clamping the hairpin and improving productivity and production efficiency.

In particular, according to an embodiment of the present disclosure, it is possible to obtain an advantageous effect of gripping the hairpin in an accurate posture and improving the performance and stability of the operation of gripping the hairpin.

In addition, according to an embodiment of the present disclosure, it is possible to obtain an advantageous effect of accurately inserting the hairpin into the target position (temporary alignment position) of the temporary alignment jig.

Among other things, according to an embodiment of the present disclosure, it is possible to accurately position the hairpin at the target position while mitigating deformation of the hairpin (minimizing deformation and distortion) even when the hairpin is deformed (or a forming deviation occurs).

In addition, according to an embodiment of the present disclosure, it is possible to obtain an advantageous effect of improving the efficiency of the process of temporarily aligning the hairpin, reducing the amount of time required for the process of temporarily aligning the hairpin, and improving the production quality.

While various embodiments have been described above, the embodiments are just illustrative and not intended to limit the present disclosure. It can be appreciated by those having ordinary skill in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A hairpin gripper comprising:
a gripper main body;
a first finger grip part provided on the gripper main body and configured to grip a first portion of a hairpin; and
a second finger grip part provided on the gripper main body and configured to grip a second portion of the hairpin independently of the first finger grip part.

2. The hairpin gripper of claim 1, wherein the first finger grip part comprises:
a first finger; and
a second finger configured to be movable toward or away from the first finger such that the first finger and the second finger collectively grip the first portion of a hairpin.

3. The hairpin gripper of claim 2, wherein the first finger grip part further comprises:
a first guide portion provided on the first finger and configured to guide one surface of a hairpin; and
a second guide portion provided on the second finger and configured to face the first guide portion and guide another surface of the hairpin,
wherein the first portion of the hairpin is guided along the first guide portion and the second guide portion and aligned between the first finger and the second finger.

4. The hairpin gripper of claim 1, wherein the second finger grip part comprises:
a first finger; and
a second finger configured to be movable toward or away from the first finger such that the first finger and the second finger collectively grip the second portion of a hairpin.

5. The hairpin gripper of claim 4, wherein the second finger grip part further comprises:
a first guide portion provided on the first finger and configured to guide one surface of a hairpin; and
a second guide portion provided on the second finger and configured to face the first guide portion and guide another surface of the hairpin,
wherein the second portion of the hairpin is guided along the first guide portion and the second guide portion and aligned between the first finger and the second finger.

6. The hairpin gripper of claim 1, wherein the second finger grip part is provided to be selectively movable rectilinearly toward or away from the first finger grip part.

7. The hairpin gripper of claim 6, comprising:
a drive part configured to provide driving power that allows the second finger grip part to rectilinearly move toward or away from the first finger grip part.

8. The hairpin gripper of claim 1, wherein a hairpin to be gripped by the hairpin gripper comprises:
a crown portion;
a first leg portion connected to one end of the crown portion; and
a second leg portion connected to another end of the crown portion,
wherein the first portion is defined as a boundary between the crown portion and the first leg portion, and
wherein the second portion is defined as a boundary between the crown portion and the second leg portion.

9. The hairpin gripper of claim 8, comprising:
a lifting part provided on the gripper main body and configured to selectively lift the crown portion in when the first finger grip part and the second finger grip part grip the hairpin.

10. The hairpin gripper of claim 9, wherein the lifting part comprises:
a lifting member provided on the gripper main body and configured to be selectively movable upward or downward; and
a hook member provided on the lifting member and configured to support the crown portion.

11. The hairpin gripper of claim 10, comprising:
a lifting drive part configured to provide driving power that allows the lifting member to move upward or downward relative to the gripper main body.

12. The hairpin gripper of claim 10, wherein the second finger grip part is provided to be selectively movable rectilinearly toward or away from the first finger grip part, and
wherein a reference height of the hook member with respect to the crown portion varies depending on a rectilinear movement of the second finger grip part relative to the first finger grip part.

13. The hairpin gripper of claim 12, comprising:
a cam follower provided on the gripper main body and configured to be selectively movable upward or downward and support the lifting member;
a first link member having one end rotatably connected to the first finger grip part, and another end rotatably connected to the cam follower; and
a second link member having one end rotatably connected to the second finger grip part, and another end rotatably connected to the other end of the first link member, and
wherein the lifting member moves upward or downward based on an upward or downward movement of the cam follower.

14. The hairpin gripper of claim 1, wherein the first finger grip part is configured to finger-grip a first portion of a hairpin, and wherein the second finger grip part is configured to finger-grip a second portion of the hairpin independently of the first finger grip part.
